(19) United States
(12) Patent Application Publication
(10) Pub. No.: US 2026/0346735 A1
(43) Pub. Date: Nov. 5, 2026

(54) Method and Device for Coupling an Electric Machine

(71) Applicant: Bayerische Motoren Werke Aktiengesellschaft, Muenchen (DE)

(72) Inventors: Jens HALBEDEL, Muenchen (DE); Christian KARGES, Muenchen (DE); Henry KRUEGER, Muenchen (DE)

(21) Appl. No.: 19/111,837

(22) PCT Filed: Oct. 17, 2023
(86) PCT No.: PCT/EP2023/078730

§ 371 Date: Mar. 14, 2025

(30) Foreign Application Priority Data
Nov. 8, 2022 (DE) 10 2022 129 429.3

(51) Int. Cl. B60L 15/20

(52) U.S. Cl. CPC B60L 15/2054; B60L 2220/42; B60L 2240/421; B60L 2240/423; B60L 2240/461; B60L 2240/50; B60L 2250/16; B60L 2250/24; B60L 2250/26; B60L 2260/26; B60L 2260/28

(57) ABSTRACT

A device is provided for coupling a second electric machine to a wheel of a vehicle by an uncoupling unit, while the vehicle is already being driven by a first electric machine. The device is configured to determine that the second electric machine is to be coupled to the wheel of the vehicle. The device is also configured to cause at least one presentation measure in response to the determination, by which the coupling of the second electric machine is made perceptible to a user of the vehicle.

### BACKGROUND AND SUMMARY

The present disclosure relates to a method and a corresponding apparatus which are directed toward coupling an electric machine to an axle of a motor vehicle.

An electrically driven motor vehicle may comprise one or more electric machines which are securely connected to an axle, for example, to the front axle or to the rear axle, of the vehicle in order to drive the axle and therefore the vehicle.

In a vehicle with all-wheel drive, the two axles of the vehicle are typically each driven by a dedicated number of electric machines. An uncoupling unit can be arranged between at least one axle and the respective number of electric machines in order to uncouple the number of electric machines selectively from the axle, for example, when all-wheel drive operation is not required and/or desirable for driving the vehicle.

The uncoupling unit may have a delay time in order to couple the number of electric machines to the axle and in order subsequently to bring about a drive torque at the axle. This delay time and the resultant where applicable sluggish build-up of the additional drive moment or torque can be perceived by a user of the vehicle to be uncomfortable and/or sluggish or unsporty.

A technical problem addressed by the present document is to increase the comfort and/or the sportiness of a vehicle when coupling an electric machine of the vehicle in an efficient manner.

An object is achieved by the present disclosure. Advantageous embodiments are described herein.

According to one aspect, there is described an apparatus for coupling a second electric machine by an uncoupling unit (such as by a clutch, for example, by a claw clutch) to a wheel of a (motor) vehicle. The vehicle can already be driven by a first electric machine. The first electric machine may be configured to drive a first axle of the vehicle and the second electric machine may be configured to drive a second axle of the vehicle (on which the at least one wheel to be driven of the vehicle is arranged). The first axle may be the front axle and the second axle may be the rear axle of the vehicle. Alternatively, the first axle may be the rear axle and the second axle may be the front axle.

The uncoupling unit may be configured to uncouple in the open state the second electric machine from the wheel (to be driven), such as from the second axle. Furthermore, the uncoupling unit may be configured to couple in the closed state the second electric machine to the wheel, such as to the second axle, so that the wheel and/or the second axle are driven by the second electric machine (if a torque is produced by the second electric machine).

Consequently, the vehicle may have a (purely) electric all-wheel drive, in which if necessary (as a result of the uncoupling unit) the second electric machine can be uncoupled from the second axle of the vehicle (in order to allow the vehicle to be operated as efficiently as possible). On the other hand, the second electric machine can again be coupled to the second axle (for example, in order to provide an increased drive moment of the vehicle).

The apparatus is configured to determine that the second electric machine is intended to be coupled to the wheel of the vehicle. For example, it is possible to identify that, in order to drive the vehicle, an additional drive moment (in addition to the drive moment generated by the first electric machine) is required and can be provided (after coupling) by the second electric machine.

The vehicle may comprise a dedicated control element, such as a switching paddle (on the steering wheel) and/or a kick-down pedal and/or an operating knob or an operating button (which allows a user, for example the driver, of the vehicle to explicitly request the coupling of the second electric machine). The apparatus may be configured to detect actuation of the control element. Based on the identified actuation, it can then be determined that the second electric machine is intended to be coupled to the wheel of the vehicle. Furthermore, the coupling of the second electric machine to the wheel of the vehicle can subsequently be brought about (via the (closed) uncoupling unit). By providing a dedicated control element for requesting the coupling of the second electric machine, a particularly comfortable coupling of the second electric machine can be brought about.

It is possible to enable, by providing a dedicated control and/or operating element, switching of the uncoupling unit to the closed state (in order to couple the second electric machine to the wheel, such as to the second axle) even before the user of the vehicle requests additional power via the accelerator pedal of the vehicle (for example, in order to initiate an overtaking operation). A torque and/or power build-up (by the second machine) may then be brought about without any delay (in response to the actuation of the accelerator pedal).

The apparatus may further be configured, in response to the determination, to bring about at least one production measure by which the coupling of the second electric machine becomes perceptible for the user, such as for the driver, of the vehicle.

It is possible to determine, for example, at an identification time, that the second electric machine is intended to be coupled to the wheel (such as to the second axle) of the vehicle. Furthermore, it is possible to cause, at a subsequent coupling time, by the apparatus, the second electric machine to be coupled via the uncoupling unit to the wheel (such as to the second axle) of the vehicle. This can be brought about by closing the uncoupling unit.

The apparatus may be configured to prepare the production measure between the identification time and the coupling time so that at the coupling time the coupling of the second electric machine is perceptible for the user of the vehicle, such as by an additional vehicle acceleration and/or by an (additional and/or changed) noise and/or by an (additional and/or changed) graphic display.

The actual coupling of the second electric machine to the wheel, such as to the second axle, of the vehicle can bring about, for example, a basic acceleration and/or a basic impulse and/or a basic noise and/or a basic display. They can be configured so that they are perceived by the user to be relatively weak and/or to be disruptive and/or not perceived at all. The at least one production measure can be directed (at the coupling time):
to bring about a production acceleration which goes beyond the basic acceleration (for example, by 10% or more); and/or
to bring about a production impulse which goes beyond the basic impulse (for example, by 10% or more); and/or
to bring about a production noise which goes beyond the basic noise (for example, by 10% or more); and/or
to bring about a production display which differs from the basic display (for example, by (additional and/or changed) animation and/or coloring and/or graphic elements of the display).

The production acceleration and/or the production impulse and/or the production noise and/or the production display can be so powerful that they are perceived by the user as a driver experience.

Consequently, an explicit, additionally perceptible production of the coupling of the second electric machine can be brought about, for example, in order to increase the comfort of the vehicle efficiently.

The apparatus may be configured to cause, in the context of a production measure, before the coupling time, a torque which is brought about by the first electric machine to be reduced, such as by a torque reserve. For example, a target torque may be provided by the first electric machine at the identification time. The apparatus may cause the torque brought about by the first electric machine (up to the coupling time) to be reduced to a reduced torque in order to produce a torque reserve. The reduced torque can, for example, be below the target torque by 5% or more.

The apparatus may further be configured to cause the torque which is brought about by the first electric machine to be increased again, such as by the torque reserve, at the coupling time at which the coupling of the second electric machine is carried out. Thus, in a particularly efficient manner, a production, which is perceptible (as a driver experience), of the coupling of the second electric machine can be brought about.

The apparatus may be configured to reduce the torque which is brought about by the first electric machine beginning with the identification time up to the coupling time, such as in a flowing manner (and consequently not perceptible for the user). Furthermore, the apparatus may be configured to cause the torque which is brought about by the first electric machine to be increased abruptly at the coupling time, such as by the torque reserve. Thus, a particularly comfortable production of the coupling can be brought about.

Alternatively or additionally, the apparatus may be configured to cause, in the context of a production measure, the speed of the second electric machine to be increased, before the coupling time, to an excessive speed which is greater than the target speed of the second electric machine for the coupling. The target speed may be dependent on the current speed of the wheel of the vehicle.

The apparatus may be configured to establish the current speed of the wheel (at the identification time). The target speed of the second electric machine can be established for the coupling, for example, so that the target speed corresponds to the current speed of the wheel (taking into consideration the step-up ratio between the shaft of the second electric machine and the wheel axle of the wheel).

It is possible to cause the second electric machine to be adjusted (between the identification time and the coupling time) to an excessive speed which is, for example, 5% or more greater than the target speed. The speed of the second electric machine can be increased to the excessive speed, beginning with the identification time, up to the coupling time.

Furthermore, it is possible to cause at the coupling time the second electric machine to be coupled via the uncoupling unit to the wheel of the vehicle. As a result of the excessive speed of the second electric machine and as a result of the inertia of the shaft of the second electric machine, an effect which is perceptible for the user is produced, for example, with respect to an additional vehicle acceleration and/or with respect to a noise by one or more loudspeakers and/or a graphic display by one or more screens of a display operating concept of the vehicle. Thus, a particularly comfortable and/or sporty production of the coupling of the second electric machine can be brought about.

The apparatus may be configured to cause, in the context of a production measure, a centrifugal unit (for example, a flywheel) to be driven before the coupling time, such as by the second electric machine. Furthermore, it is possible to cause, at the coupling time, the second electric machine and the driven centrifugal unit to be coupled via the uncoupling unit to the wheel of the vehicle so that, as a result of the driven centrifugal unit, an effect which is perceptible for the user is produced, for example, with respect to an additional vehicle acceleration and/or with respect to a noise by one or more loudspeakers and/or a graphic display by one or more screens of a display operating concept of the vehicle. Thus, a particularly comfortable and/or sporty production of the coupling can be brought about.

It may be noted that the one or more production measures which are described in this document can be used accordingly in order to produce an additional (perceptible) deceleration of the vehicle (for example, when the coupling of the second electric machine is brought about in order to recover electrical energy from the kinetic energy of the vehicle).

The apparatus can be configured to determine that the second electric machine is intended to be coupled to the wheel of the vehicle for recovery. In the context of a production measure, it is then possible to cause the speed of the second electric machine to be adjusted, before the coupling time, to a reduced speed which is less than the target speed of the second electric machine.

The apparatus may further be configured to cause, at the coupling time, the second electric machine to be coupled to the wheel of the vehicle via the uncoupling unit so that, as a result of the reduced speed of the second electric machine and as a result of an inertia of a shaft of the second electric machine, an effect which is perceptible for the user is produced, such as with respect to an additional vehicle deceleration and/or with respect to a noise by one or more loudspeakers and/or with respect to a graphic display by one or more screens of a display operating concept of the vehicle. Thus, a particularly comfortable and/or sporty production of the coupling can be brought about.

The apparatus may be configured to establish the travel speed and/or the acceleration of the vehicle (for example, the travel speed and/or the acceleration at the identification time). The one or more production measures can then be brought about in accordance with the travel speed and/or the acceleration of the vehicle. The magnitude and/or the strength of the one or more production measures, for instance, the extent of the torque reserve, which is brought about in the context of a production measure, of the first electric machine and/or the extent of the excessive speed, which is brought about in the context of a production measure, of the second electric machine, can be adapted in accordance with the travel speed and/or the acceleration.

The apparatus may be configured to bring about one or more production measures if the travel speed is less than a speed threshold value and/or if the acceleration is less than an acceleration threshold value. Alternatively or additionally, the apparatus may be configured not to bring about one or more production measures and/or to prevent them if the travel speed is greater than the speed threshold value and/or if the acceleration is greater than the acceleration threshold value. Alternatively or additionally, the magnitude of the one or more measures, such as the extent of the torque reserve and/or the extent of the excessive speed, can be decreased with an increasing travel speed and/or with an increasing acceleration and/or increased with a decreasing travel speed and/or with a decreasing acceleration.

The production of the coupling of the second electric machine can consequently be brought about in accordance with the current travel speed and/or the current acceleration of the vehicle, respectively. Thus, for example, the comfort and/or the driver experience of the vehicle can be further increased.

Alternatively or additionally, the one or more production measures can be brought about in accordance with one or more ambient conditions of the environment of the vehicle. An exemplary ambient condition is the friction coefficient of the carriageway, on which the vehicle is travelling. Alternatively or additionally, the one or more production measures can be brought about or not brought about in accordance with data of a navigation system of the vehicle, for example, in accordance with a type of road (for instance, motorway, country road, urban road, play street, etc.) on which the vehicle is travelling. Thus, for example, the comfort and/or the driver experience of the vehicle can be further increased.

According to another aspect, a (road) motor vehicle (such as a passenger vehicle or a lorry or a bus or a motorcycle) which comprises the apparatus described in this document is described.

According to another aspect, there is described a method for coupling a second electric machine by an uncoupling unit (for example, by a clutch) to at least one wheel of a (motor) vehicle while the vehicle is already being driven by a first electric machine. The method comprises determining that the second electric machine is intended to be coupled to the wheel of the vehicle. The method further comprises, in response to the determination, at least one production measure, by which the coupling of the second electric machine for a user of the vehicle becomes perceptible, being brought about.

According to another aspect, a software (SW) program is described. The software program may be configured in order to be carried out on a processor (for example, on a control device of a vehicle) and in order to thereby carry out the method described in this document.

According to another aspect, a storage medium is described. The storage medium may comprise a software program which is configured in order to be carried out on a processor and in order thereby to carry out the method described in this document.

It should be noted that the methods, apparatuses and systems described in this document can be used both alone and in conjunction with other methods, apparatuses and systems described in this document. Furthermore, any aspects of the methods, apparatuses and systems described in this document can be combined with each other in various manners. The features of the disclosure can be combined with each other in various manners. Furthermore, features set out in parentheses are intended to be understood to be optional features.

Furthermore, the disclosure is described in greater detail with reference to exemplary embodiments.

### BRIEF DESCRIPTION OF THE DRAWINGS

FIG. 1 shows exemplary components of a vehicle;

FIG. 2a shows an exemplary time progression of the speed of an electric machine in the context of a coupling operation;

FIG. 2b shows an exemplary time progression of the torque and/or drive moment which is brought about by an already-coupled electric machine in the context of a coupling operation of another electric machine; and

FIG. 3 shows a flow diagram of an exemplary method for coupling an electric machine to an axle of a vehicle.

### DETAILED DESCRIPTION OF THE DRAWINGS

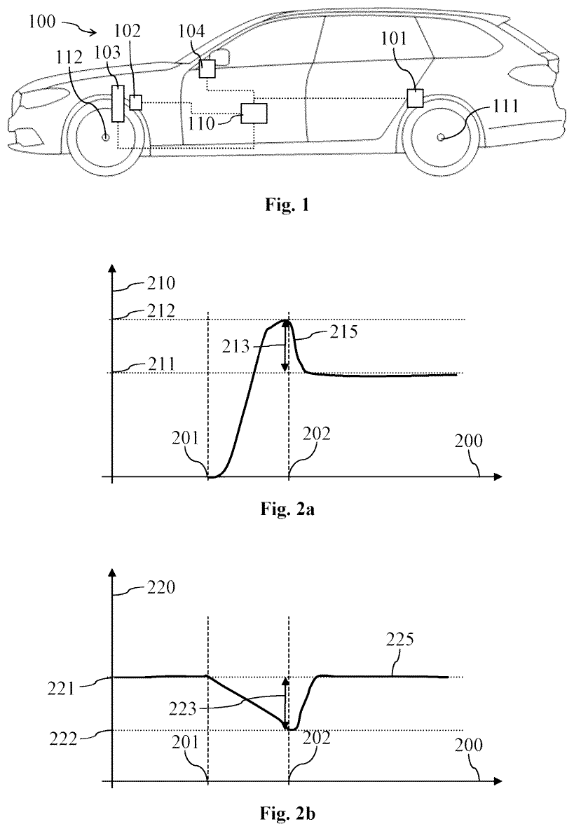

As set out in the introduction, the present document relates to the increase in comfort of a user when coupling an electric machine. In this context, FIG. 1 shows an exemplary vehicle 100 which comprises a first electric machine 101 which is configured to drive a first axle 111 (for example, the rear axle) of the vehicle 100. The first electric machine 101 may where applicable be securely coupled to the first axle.

The vehicle 100 further comprises a second electric machine 102 which is configured to drive a second axle 112 (for example, the front axle) of the vehicle 100. It is possible to arrange between the second electric machine 102 and the second axle 112 an uncoupling unit 103 (for example, a (claw) clutch) which is configured to selectively couple or uncouple the second electric machine 102 to/from the second axle 112.

The vehicle 100 can further comprise one or more control elements 104 which allow a user, for example the driver, of the vehicle 100 to control the drive of the vehicle 100. Exemplary control elements 104 are an accelerator pedal (for example, a kick-down pedal) and/or a switching paddle.

The vehicle 100 which is illustrated in FIG. 1 is consequently an all-wheel drive vehicle 100, in which all the wheels of the vehicle 100 can be driven by one or more electric machines 101, 102 (indirectly via the axles 111, 112). In specific driving situations, it may be advantageous, for example with regard to energy consumption, to uncouple the second electric machine 102 from the second axle 112, such as when a sufficiently high torque can be provided by the first electric machine 101 in order to drive the vehicle 100 (for example, during uniform motorway driving).

It is possible for a (control) apparatus 110 of the vehicle 100 to identify and/or determine that the second electric machine 102 should be coupled to the second axle 102, for example, in order to provide an additional drive moment. It is subsequently possible to cause the second electric machine 102 to be activated and the speed of the second electric machine 102 to be adapted to the current travel speed of the vehicle 100 and/or the current speed of the second axle 112. Furthermore, it is possible to cause the second electric machine 102 to be coupled to the second axle 112 via the uncoupling unit 103 (such as by closing the uncoupling unit).

The coupling process brought about by the uncoupling unit 103 may have a specific delay time. This can result in the torque which is generated by the second electric machine 102 being transmitted to the second axle 112 with a time delay and/or with a specific start-up gradient (that is to say, sluggish). This can be perceived by a user, for example by the driver, of the vehicle 100 to be unpleasant. Furthermore, such a sluggish coupling of the second electric machine 102 requires the use of a relatively complex coupling within the uncoupling unit 103, which involves additional costs and/or structural space and/or weight.

This document describes a method, by which an active production of the coupling process, which can be perceived by the user, such as by the driver, of the vehicle 100, is brought about. In the context of the production, one or more production measures which at least partially result in a build-up, which is perceptible for the driver, of an additional torque and/or driving moment (associated with the coupling process) can be brought about. Thus, the comfort for the user can be increased. Furthermore, the use of a relatively cost-efficient coupling, such as a claw clutch, can thus be enabled within the uncoupling unit 103.

The (control) apparatus 110 may, for example, identify based on the actuation of a control element 104 of the vehicle 100 that the second electric machine 102 is intended to be coupled to the second axle 112. The control element 104 may be, for example, a switching paddle and/or a kick-down paddle. Consequently, a control element 104 which explicitly allows the user of the vehicle 100 to bring about the coupling of the second electric machine 102 can be provided.

As illustrated in FIGS. 2a and 2b, for example, it is possible to identify at an identification time 201 that the second electric machine 102 is intended to be coupled to the second axle 112. In response thereto, the second electric machine 102 can be activated and accelerated (see FIG. 2a). For example, a target speed 211 for the second electric machine 102 which is dependent on the travel speed of the vehicle 100 and/or the speed of the second axle 112 can be established. The target speed 211 may correspond, for example, to the speed of the second axle 112 (according to the step-up ratio of an optional gear mechanism of the uncoupling unit 103).

It is possible to cause, as a production measure, the second electric machine 102 to be accelerated to an excessive speed 212 which is higher than the target speed 211 before the coupling time 202, at which the coupling to the second axle 112 is carried out. This is illustrated by the time progression 215, illustrated in FIG. 2a, of the speed 210 (which indicates the speed 210 of the second electric machine 102 as a function of the time 200).

The second electric machine 102 consequently has at the coupling time 202 an excessive speed 212 which is above the target speed 211 by the offset value 213 (for example, by 5% or more or 10% or more). Consequently, during the coupling of the second electric machine 102 an additional acceleration of the vehicle 100 which is perceived by the user of the vehicle 100 as a driver experience when connecting the second electric machine 102 is brought about.

Alternatively or additionally, before the coupling of the second electric machine 102, a reduction of the torque which is brought about by the first electric machine 101 at the first axle 111 can be brought about as a production measure, as illustrated in FIG. 2b by way of example. The first electric machine 101 brings about a target torque 221, for example, before the coupling operation (for example, at the identification time 201). In response to the identification of the coupling to be brought about of the second electric machine 102, from the identification time 201 the torque 220 which is brought about by the first electric machine 101 can be reduced to a reduced torque 222 (which is less than the target torque 221 (for example, by 5% or more or 10% or more).

By reducing the torque 220 which is generated by the first electric machine 101, an additional torque reserve 223 can be generated. At the coupling time 202, the torque 220 which is generated by the first electric machine 101 can again be increased to the target torque 221 in order to make the additional torque reserve 223 perceptible for the user of the vehicle 100 (as a driver experience). This is illustrated in FIG. 2b by way of example by the time progression 225 of the torque 220.

In the context of the coupling of the second electric machine 102, consequently, one or more production measures can be brought about in order to increase the comfort for the user of the vehicle 100. The one or more production measures can be brought about in accordance with the current travel speed of the vehicle 100 (at the identification time 201). The magnitude of the one or more production measures can be reduced with an increasing travel speed. Where applicable, the one or more production measures can be brought about only when the travel speed of the vehicle 100 is less than a speed threshold value. On the other hand, where applicable, a flowing coupling of the second electric machine 102 can be brought about when the travel speed of the vehicle 100 is greater than the second speed threshold value.

As already set out in the introduction, electric vehicles 100 typically do not have a coupling between the one or more electric motors 101, 102 and one or more wheels of the vehicle 100, but are instead directly coupled. In all-wheel drive vehicles 100, one or more electric motors 101, 102 can be fitted per axle 111, 112 and directly coupled to the driven axle 111, 112. This direct coupling allows a very dynamic characteristic of the electric drive with respect to the build-up of moment in accordance with the driver's wishes (for example, pedal request). For constant journeys of the vehicle 100 (at a constant travel speed), one driven axle 111 in the vehicle 100 is typically sufficient, for which reason the other axle 112 can be deactivated or also uncoupled as a result of efficiency advantages. This coupling and uncoupling can be carried out in the background, as far as possible in a manner imperceptible for the user and/or in a sluggish manner with respect to the increase or decrease of torque.

The coupling and uncoupling of an electric machine 102 via an uncoupling unit 103 typically acts as a delay time during the torque increase. The result is a delayed and/or sluggish torque increase for dynamic accelerator pedal requests in comparison with a system without any uncoupling unit 103 or for a permanently closed uncoupling unit 103.

This document proposes (at least for travel speeds which are less than a speed threshold value; and/or in accordance with the travel speed and/or in accordance with one or more external peripheral conditions) not carrying out any concealment of the delay time of the uncoupling unit 103 via a delayed and/or sluggish torque increase but instead bringing about a deliberate production of the connection (that is to say, the closure) of the uncoupling unit 103 via a specific torque increase. Consequently, the connection can be used as an emotion-provoking means.

For this purpose, a coupling and/or a direct switching can be brought about via a user interaction at a control element 104 (for example, at a switching paddle and/or at a kick-down pedal). The user can consequently actuate the control element 104 in order to bring about the coupling of the second electric machine 102.

Another exemplary production measure is the overspeeding of the non-coupled (second) electric machine 102 before being coupled in order to use the moment of inertia as additional punch potential. This generates an additional acceleration peak during coupling and/or an additional acoustic excessive increase which can be used for production.

Before the connection of the second electric machine 102, a centrifugal unit (for example, with a flywheel mass, for example, a flywheel) can be driven as an additional exemplary production measure. The centrifugal unit can be driven, for example, by the second electric machine 102. The centrifugal unit can then also be coupled when the second electric machine 102 is connected in order to bring about an additional acceleration which can be used for the production.

Before the second (where applicable rear) electric machine 102 is connected via the uncoupling unit 103, the first (for example, front) electric machine 102 may provide only a reduced moment 222 as an additional exemplary production measure so that the moment potential 223, which is felt by the user, of the entire drive train during coupling increases.

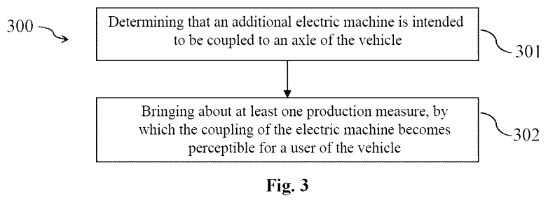

FIG. 3 shows a flow diagram of a method 300 (where applicable, implemented by computer) for coupling a second electric machine 102 by an uncoupling unit 103 to a wheel of a vehicle 100 while the vehicle 100 is already being driven by a first electric machine 101. The first electric machine 101 may be configured to drive one or more wheels on a first axle 111 of the vehicle 100. The second electric machine 102 may be configured to drive one or more wheels on a second axle 112 of the vehicle 100 if the second electric machine 102 is coupled to the second axle 112 and consequently to the one or more wheels on the second axle 112.

The method 300 comprises determining 301 that the second electric machine 102 is intended to be coupled to the wheel of the vehicle 100 (in order to drive the wheel). This can be identified, for example, based on the actuation of a control element 104 of the vehicle 100. The determination 301 can be carried out at an identification time 201.

The method 300 further comprises, in response to the determination 301, bringing about 302 at least one production measure by which the coupling of the second electric machine 102 becomes perceptible for a user of the vehicle 100. In other words, in the context of the coupling process an (additional) production measure can be brought about and is perceptible for the user of the vehicle 100 (for example, acoustically and/or as an additional acceleration).

By the second electric machine 102 being coupled to the wheel, where applicable a basic impulse and/or a basic acceleration and/or a basic noise and/or a basic display can be brought about (for instance, as a result of the closure of the uncoupling unit 103). The at least one production measure may be configured so that, as a result of the measure, an impulse which goes beyond the basic impulse and/or an acceleration which goes beyond the basic acceleration and/or a noise which goes beyond the basic noise and/or a display which goes beyond the basic display is brought about. Thus, it is possible to cause the coupling of the second electric machine 102 to be perceived by the user as a driver experience (and not as a disruptive effect).

The measures described in this document enable the comfort of a user of a vehicle 100 to be increased in the context of the coupling of an electric machine 102. Furthermore, a particularly efficient uncoupling or coupling of an electric machine 102 can be enabled (for example, by using a claw clutch).

The present disclosure is not limited to the exemplary embodiments set out. It should particularly be noted that the description and Figures are intended to depict the principle of the proposed methods, apparatuses and systems only in an exemplary manner.

1-14. (canceled)

15. An apparatus for coupling a second electric machine, by an uncoupling unit, to a wheel of a vehicle while the vehicle is already being driven by a first electric machine, wherein the apparatus is configured to:
determine that the second electric machine is intended to be coupled to the wheel of the vehicle; and
in response to the determination, bring about at least one production measure by which the coupling of the second electric machine becomes perceptible for a user of the vehicle.

16. The apparatus according to claim 15, wherein the apparatus is configured, based on the at least one production measure, to:
cause, before a coupling time, a torque which is brought about by the first electric machine to be reduced by a torque reserve; and
cause the torque brought about by the first electric machine at the coupling time, at which the coupling of the second electric machine is carried out, to be increased again by the torque reserve.

17. The apparatus according to claim 16, wherein the apparatus is configured to:
cause the torque which is brought about by the first electric machine to be increased abruptly at the coupling time by the torque reserve.

18. The apparatus according to claim 16, wherein the apparatus is configured to:
reduce the torque which is brought about by the first electric machine beginning with an identification time at which it is determined that the second electric machine is intended to be coupled to the wheel of the vehicle up to the coupling time in a flowing manner.

19. The apparatus according to claim 15, wherein the apparatus is configured, based on the at least one production measure, to:
cause a speed of the second electric machine to be increased, before a coupling time, to an excessive speed which is greater than a target speed of the second electric machine; wherein the target speed is dependent on a current speed of the wheel of the vehicle; and
cause at the coupling time the second electric machine to be coupled via the uncoupling unit to the wheel of the vehicle so that, as a result of the excessive speed of the second electric machine and of an inertia of a shaft of the second electric machine, an effect which is perceptible for the user is produced with respect to an additional vehicle acceleration, a noise, and/or a graphic display.

20. The apparatus according to claim 19, wherein the apparatus is configured to:
increase the speed of the second electric machine to the excessive speed, beginning with an identification time, at which it is determined that the second electric machine is intended to be coupled to the wheel of the vehicle, up to the coupling time.

21. The apparatus according to claim 15, wherein the apparatus is configured to:
determine that the second electric machine is intended to be coupled to the wheel of the vehicle for recovery;
based on the at least one production measure, cause a speed of the second electric machine to be adjusted, before a coupling time, to a reduced speed which is less than a target speed of the second electric machine; wherein the target speed is dependent on a current speed of the wheel of the vehicle; and
cause, at the coupling time, the second electric machine to be coupled to the wheel of the vehicle via the uncoupling unit so that, as a result of the reduced speed of the second electric machine and of an inertia of a shaft of the second electric machine, an effect which is perceptible for the user is produced with respect to an additional vehicle deceleration, a noise, and/or a graphic display.

22. The apparatus according to claim 15, wherein the apparatus is configured to:
determine, at an identification time, that the second electric machine is intended to be coupled to the wheel of the vehicle;
cause, at a subsequent coupling time, the second electric machine to be coupled via the uncoupling unit to the wheel of the vehicle by closing the uncoupling unit; and
prepare the at least one production measure between the identification time and the subsequent coupling time so that, at the subsequent coupling time, the coupling of the second electric machine is perceptible for the user of the vehicle by an additional vehicle acceleration and/or by a noise and/or by a graphic display.

23. The apparatus according to claim 15, wherein the vehicle includes a control element comprising a switching paddle and/or a kick-down pedal, and wherein the apparatus is configured to:
detect actuation of the control element; and
based on the detected actuation, determine that the second electric machine is intended to be coupled to the wheel of the vehicle.

24. The apparatus according to claim 15, wherein the apparatus is configured to:
establish a travel speed and/or an acceleration of the vehicle; and
bring about one or more production measures in accordance with the travel speed and/or the acceleration of the vehicle to adapt a magnitude of the one or more production measures, wherein the one or more production measures comprise an extent of a torque reserve of the first electric machine and/or an extent of an excessive speed of the second electric machine in accordance with the travel speed and/or the acceleration.

25. The apparatus according to claim 24, wherein the apparatus is configured to:
bring about the one or more production measures if the travel speed is less than a speed threshold value and/or if the acceleration is less than an acceleration threshold value;
and/or not bring about the one or more production measures if the travel speed is greater than the speed threshold value and/or if the acceleration is greater than the acceleration threshold value; and/or
decrease the magnitude of the one or more production measures include the extent of the torque reserve and/or the extent of the excessive speed, with an increasing travel speed and/or with an increasing acceleration.

26. The apparatus according to claim 15, wherein:
the first electric machine is configured to drive a first axle of the vehicle;
the second electric machine is configured to drive a second axle of the vehicle; and
the first axle is a front axle and the second axle is a rear axle, or the first axle is the rear axle and the second axle is the front axle.

27. The apparatus according to claim 15, wherein the apparatus is configured, based on the at least one production measure, to:
cause a centrifugal unit to be driven before a coupling time by the second electric machine; and
cause, at the coupling time, the second electric machine and the driven centrifugal unit to be coupled via the uncoupling unit to the wheel of the vehicle so that, as a result of the driven centrifugal unit, an effect which is perceptible for the user is produced with respect to an additional vehicle acceleration, a noise, and/or a graphic display.

28. A method for coupling a second electric machine by an uncoupling unit to a wheel of a vehicle while the vehicle is already being driven by a first electric machine; wherein the method comprises:
determining that the second electric machine is intended to be coupled to the wheel of the vehicle; and
in response to the determination, bringing about at least one production measure, by which the coupling of the second electric machine for a user of the vehicle becomes perceptible.

29. The method according to claim 28, further comprising, based on the at least one production measure:
causing, before a coupling time, a torque which is brought about by the first electric machine to be reduced by a torque reserve; and
causing the torque brought about by the first electric machine at the coupling time, at which the coupling of the second electric machine is carried out, to be increased again by the torque reserve.

30. The method according to claim 28, further comprising:
causing a speed of the second electric machine to be increased, before a coupling time, to an excessive speed which is greater than a target speed of the second electric machine; wherein the target speed is dependent on a current speed of the wheel of the vehicle; and
causing at the coupling time the second electric machine to be coupled via the uncoupling unit to the wheel of the vehicle so that, as a result of the excessive speed of the second electric machine and of an inertia of a shaft of the second electric machine, an effect which is perceptible for the user is produced with respect to an additional vehicle acceleration, a noise, and/or a graphic display.

31. The method according to claim 28, further comprising:
determining that the second electric machine is intended to be coupled to the wheel of the vehicle for recovery;
based on the at least one production measure, causing a speed of the second electric machine to be adjusted, before a coupling time, to a reduced speed which is less than a target speed of the second electric machine; wherein the target speed is dependent on a current speed of the wheel of the vehicle; and
causing, at the coupling time, the second electric machine to be coupled to the wheel of the vehicle via the uncoupling unit so that, as a result of the reduced speed of the second electric machine and of an inertia of a shaft of the second electric machine, an effect which is perceptible for the user is produced with respect to an additional vehicle deceleration, a noise, and/or a graphic display.

32. The method according to claim 28, further comprising:
determining, at an identification time, that the second electric machine is intended to be coupled to the wheel of the vehicle;
causing, at a subsequent coupling time, the second electric machine to be coupled via the uncoupling unit to the wheel of the vehicle by closing the uncoupling unit; and
preparing the production measure between the identification time and the subsequent coupling time so that, at the subsequent coupling time, the coupling of the second electric machine is perceptible for the user of the vehicle by an additional vehicle acceleration and/or by a noise and/or by a graphic display.

33. The method according to claim 28, wherein the vehicle includes a control element comprising a switching paddle and/or a kick-down pedal, and wherein the method further comprises:
detecting actuation of the control element; and
based on the detected actuation, determining that the second electric machine is intended to be coupled to the wheel of the vehicle.

34. The method according to claim 28, further comprising:
establishing a travel speed and/or an acceleration of the vehicle; and
bringing about one or more production measures in accordance with the travel speed and/or the acceleration of the vehicle to adapt a magnitude of the one or more production measures, wherein the one or more production measures comprise an extent of a torque reserve of the first electric machine and/or an extent of an excessive speed of the second electric machine in accordance with the travel speed and/or the acceleration.
